(19) United States
(12) Patent Application Publication
(10) Pub. No.: US 2012/0098627 A1
(43) Pub. Date: Apr. 26, 2012

(54) COMMON MODE FILTER

(75) Inventor: Masaaki Kameya, Kanagawa (JP)

(73) Assignee: ELMEC Corporation, Kawasaki-Shi, Kanagawa (JP)

(21) Appl. No.: 13/379,262

(22) PCT Filed: Jul. 7, 2009
(86) PCT No.: PCT/JP2009/062349

§ 371 Date: Dec. 19, 2011

(51) Int. Cl. H01P 1/203

(52) U.S. Cl. 333/204

(57) ABSTRACT

To pass an ultrahigh speed differential signal and sufficiently attenuate a common mode signal on an ultrahigh speed differential transmission line. A pair of conductor lines 1A and 1B are formed on one side of a dielectric layer 3 in parallel to each other. A floating ground 5 is formed on the other side of the dielectric layer 3 so as to face the conductor lines 1A and 1B. The floating ground 5 is not connected to an external common ground 7 and is formed independently. A passive two terminal circuit CM1 composed of passive circuit elements is connected between a connection point 9 between the floating ground 5 and a common ground 7.

### TECHNICAL FIELD

The present invention relates to a common mode filter, and particularly to a new common mode filter capable of securing a transmission of an ultrahigh speed differential signal which is propagated through an ultrahigh speed differential line, and attenuating a common mode signal.

### DESCRIPTION OF RELATED ART

In recent years, high definition video contents such as “HDTV: high definition television” and “Blu-ray Disc” are widespread. In order to transmit an enormous amount of digital data that supports such contents at a high speed, an ultrahigh speed serial transmission has been used.

In the ultrahigh speed serial transmission, small voltage amplitude is required for shortening a rise time, thus deteriorating a noise resistance property. Therefore, in order to improve the noise resistance property, a differential transmission system generally used.

This differential transmission system is capable of ensuring a smaller amplitude for a higher transmission speed and electric power saving, and attenuating a common mode signal such as an external noise, by simultaneously transmitting in-phase and opposite-phase differential signals to each of two lines which are formed as a pair.

However, in the differential transmission system, a function of attenuating the common mode signal such as the external noise is insufficient. Therefore, in order to avoid an adverse influence, a common mode choke coil is inserted to the differential transmission line, to cope with such an adverse influence.

Conventionally, although not shown, this kind of common mode choke coil is formed by winding two conducting wires around a magnetic bobbin by the same number of turns, and a common mode choke coil with this structure is well-known. FIG. 26 is a circuit view showing this structure.

In the common mode choke coil with this structure, differential signals flowing through the two conducing wires are in the opposite phase state, to thereby mutually negate a magnetic flux generated at this time. Therefore, impedance of two conducting wires is maintained to be low, thus easily transmitting the differential signals.

Meanwhile, the common mode signal flows through two conducting wires in the in-phase state, and all magnetic fluxes generated in a magnetic body are totaled, to thereby increase the impedance of two conducting wires and hardly allow the common mode signal to pass. Therefore, the attenuation of the common mode signal is achieved.

Japanese Patent Laid Open Publication No. 2000-58353 (Patent document 1) discloses a common mode choke coil for a differential transmission line, corresponding to the aforementioned structure of FIG. 26.

According to patent document 1, two coil conductors wound around a toroidal core, is accommodated in an outer case made of resin composed of a case part and a lid part thereof, and ground conductors are formed by plating on an outside surface of an outer peripheral wall of the case part, and an outer surface of a bottom wall, and an outer surface of the lid part, with insulating films formed on the ground conductors, and terminal boards are respectively bonded to the surfaces of the insulating films, with end portions of the coil conductors soldered to the terminal boards, to thereby make characteristic impedance matched with the transmission line so that a reflection of a signal is suppressed.

### PRIOR ART DOCUMENT

### Patent Document

Patent document 1
Japanese Patent Laid Open Publication No. 2000-58353

### DISCLOSURE OF THE INVENTION

### Problem to be solved by the Invention

In recent years, in the aforementioned differential transmission system, a signal transmission speed of 3G to 6G bits/second is desired, and in the near future, it is said that the transmission speed of 8G to 16G bits/second is requested.

However, even if the common mode choke coil with the aforementioned structure shown in FIG. 26 is formed corresponding to a highest frequency, only transmission characteristic Sdd21 of a differential signal and transmission characteristic Scc21 of a common mode signal as shown in FIG. 27 can be obtained.

As is clarified from FIG. 27, the transmission characteristic Scc21 of the common mode signal takes a V-shape, and although attenuation of about −20 dB is obtained in a bandwidth of 2 to 3 GHz, only a slight attenuation is obtained in a bandwidth of 8 to 10 GHz, thus making it difficult to sufficiently attenuate the common mode signal.

Namely, according to a conventional structure of FIG. 26, the transmission characteristic Scc21 of the common mode signal almost reaches its limit, thus making it difficult to cope with excellent transmission of the ultrahigh speed differential signal which is required hereafter.

Further, the common mode signal not transmitted, is possibly reflected by an input port of the common mode choke coil, then propagated through the transmission line reverse-directionally, and electromagnetically radiated to outside while being multiply-reflected, resulting in easily causing a noise to occur.

Particularly, owing to a short wavelength of a GHz-band, there is a high possibility that the wavelength becomes an integral multiple of a circuit pattern length. Accordingly, there is a high possibility that the signal of the GHz-band is electromagnetically radiated, using the circuit pattern as an antenna.

Therefore, regarding a low-frequency signal with little risk of electromagnetic radiation, there is no practical problem even if the common mode signal is reflected by the input port. However, regarding a high frequency common mode signal, the reflection thereof can't be ignored and this can lead to a problem.

In order to solve the above-described problem, the present invention is provided, and an object of the present invention is to provide a common mode filter capable of excellently transmitting a desired ultrahigh speed differential signal through a ultrahigh speed differential transmission line, and capable of attenuating an undesirable common mode signal not only by reflected cutting off but also by absorption inside.

### Means for Solving the Problem

In order to solve the above-described problem, claim 1 of the present invention provides a common mode filter comprising:

a pair of conductor lines formed on a first dielectric layer and configured to transmit a differential signal;

a first floating ground separated from an external ground potential, and formed to face the conductor lines with the first dielectric layer interposed between them, and configured to form a distributed constant-type differential transmission line for transmitting the differential signal, together with the conductor lines; and

one or more first passive two terminal circuits connected between the first floating ground and the external ground potential.

Claim 2 of the present invention provides the common mode filter, wherein the first floating ground is divided into a plurality of parts in a length direction of the conductor lines, and the first passive two terminal circuit is connected between all of the divided floating grounds or any one of them, and the external ground potential.

Claim 3 of the present invention provides the common mode filter, comprising a first common ground which is arranged between the first floating ground and the first common ground with the first passive two terminal circuit disposed between them, and connected to the external ground, wherein the first passive two terminal circuit is connected between respective end portions of the first floating ground and the first common ground.

Claim 4 of the present invention provides the common mode filter, wherein the first common ground is disposed at a position opposed to the first floating ground, and the first passive two terminal circuit is connected between respective end portions thereof at the opposed position.

Claim 5 of the present invention provides the common mode filter, wherein the divided first floating grounds are formed so that the first passive two terminal circuit is connected between all or a part of the adjacent divided floating grounds.

Claim 6 of the present invention provides the common mode filter, comprising a second floating ground separated from the external ground potential, and formed to face the conductor lines with a second dielectric layer interposed between them, and configured to form a distributed constant-type differential transmission line.

Claim 7 of the present invention provides the common mode filter, comprising one or more second passive two terminal circuits connected between the second floating ground and the external ground potential.

Claim 8 of the present invention provides the common mode filter, wherein the second floating ground is divided into a plurality of parts in a length direction of the conductor lines, and the second passive two terminal circuit is connected between all or any one of the divided floating grounds, and the external ground potential.

Claim 9 of the present invention provides the common mode filter, comprising a second common ground connected to the external ground, with the second passive two terminal circuit disposed between them, wherein the second passive two terminal circuit is connected between respective end portions of the second floating ground and the second common ground.

Claim 10 of the present invention provides the common mode filter, wherein the second common ground is disposed at a position opposed to the second floating ground, and the second passive two terminal circuit is connected between respective end portions thereof at the opposed position.

Claim 11 of the present invention provides the common mode filter, wherein the divided second floating grounds are formed so that the second passive two terminal circuit is connected between all or a part of the adjacent divided floating grounds.

Claim 12 of the present invention provides the common mode filter, wherein the first and second passive two terminal circuits are short circuited lines, wherein a distance between connection points connected to each floating ground in a direction of the conductor lines, is ½ or less of a length of the floating ground in the direction of the conductor lines.

Claim 13 of the present invention provides the common mode filter, wherein the first and second passive two terminal circuits are composed of inductance, capacitance, resistance, or a combination of them as passive elements, and a distance between farthest two points in a direction of the conductor lines at the connection points connected to each floating ground, is ½ or less of a length of the floating ground in the direction of the conductor lines.

### Advantage of the Invention

According to the common mode filter of claim 1 of the present invention with this structure, the common mode signal is cut off and absorbed by the distributed constant-type differential transmission line formed by the conductive line and the first floating ground, and the first passive two terminal circuit connected between the first floating ground and the external ground potential. Therefore, the ultrahigh speed differential signal can be excellently transmitted and the common mode signal can be sufficiently attenuated in a microstrip line structure.

According to the common mode filter of claim 2 of the present invention, the first floating ground is divided into a plurality of parts in the length direction of the conductor lines, and the first passive two terminal circuit is connected between these divided floating grounds and the external ground. Therefore, various attenuation characteristics for cutting off and absorbing the common mode signal can be obtained in the microstrip line structure.

According to the common mode filter of claim 3 of the present invention, there is provided the first common mode ground connected to the external ground with the first passive two terminal circuit disposed between them, with the first passive two terminal circuit connected between respective end portions of the first floating ground and the first common ground. Therefore, in addition to the aforementioned effect, a planar structure can be easily obtained and a simple structure can be easily obtained.

According to the common mode filter of claim 4 of the present invention, the first common ground is disposed at the position opposed to the first floating ground, and the first passive two terminal circuit is connected between respective end portions at the opposed position. Therefore, similarly the planar structure can be easily obtained, and also the simple structure can be easily obtained.

According to the common mode filter of claim 5 of the present invention, the divided first floating grounds are formed so that the first passive two terminal circuit is connected between all or apart of the adjacent divided floating grounds. Accordingly, the common mode signal takes a route of returning to the common ground via the adjacent floating grounds, and further more passive two terminal circuits are connected in series on the route. Therefore, various attenuation characteristics for cutting off and absorbing the common mode signal can be efficiently and easily obtained.

According to the common mode filter of claim 6 of the present invention, there is provided a second floating ground separated from the external ground potential, and formed to face the conductor lines with a second dielectric layer interposed between them, and configured to form a distributed constant-type differential transmission line. Therefore, the attenuation characteristic for sufficiently attenuating the common mode signal can be obtained in the strip line structure.

According to the common mode filter of claim 7 of the present invention, there are provided one or more second passive two terminal circuits connected between the second floating ground and the external ground potential. Therefore, various attenuation characteristics for cutting off and absorbing the common mode signal can be easily obtained in the strip line structure.

According to the common mode filter of claim 8 of the present invention, the second floating ground is divided into a plurality of parts in the length direction of the conductor lines, and the second passive two terminal circuit is connected between all or any one of the divided floating grounds, and the external ground potential. Therefore, similarly, various attenuation characteristics for cutting off and absorbing the common mode signal can be easily obtained.

According to the common mode filter of claim 9 of the present invention, there is provided the second common ground connected to the external ground, with the second passive two terminal circuit disposed between them, wherein the second passive two terminal circuit is connected between respective end portions of the second floating ground and the second common ground. Therefore, in addition to the aforementioned effect, the planar structure can be easily obtained and also the simple structure can be easily obtained.

According to the common mode filter of claim 10 of the present invention, the second common ground is disposed at a position opposed to the second floating ground, and the second passive two terminal circuit is connected between respective end portions at the opposed position. Therefore, similarly the planar structure can be obtained, and also the simple structure can be obtained.

According to the common mode filter of claim 11 of the present invention, the divided second floating grounds are formed so that the second passive two terminal circuit is connected between all or a part of the adjacent divided floating grounds. Accordingly, the common mode signal takes a rout of returning to the second common around via the adjacent second floating grounds, and further more passive two terminal circuits are connected in series on the route. Therefore, various attenuation characteristics for cutting off and absorbing the common mode signal can be efficiently obtained.

According to the common mode filter of claim 12 of the present invention, the first and second passive two terminal circuits are short circuited lines, wherein a distance between connection points connected to each floating ground in a direction of the conductor lines, is ½ or less of a length of the floating ground in the direction of the conductor lines. Therefore, excellent attenuation characteristic can be further reliably obtained.

According to the common mode filter of claim 13 of the present invention, the first and second passive two terminal circuits are composed of inductance, capacitance, resistance, or a combination of them as passive elements, and a distance between farthest two points in a direction of the conductor lines at the connection points connected to each floating ground is ½ or less of a length of the floating ground in the direction of the conductor lines. Therefore, excellent attenuation characteristic can be further reliably obtained, even in the structure of using a plurality of first and second passive two terminal circuits.

### BRIEF DESCRIPTION OF THE DRAWINGS

FIG. 1 is cross-sectional view for describing a basic structure of a common mode filter of the present invention.

FIG. 2 is an exploded perspective view showing the common mode filter according to an embodiment of the present invention.

FIG. 3 is a transmission characteristic view of the common mode filter of FIG. 2.

FIG. 4 is a transmission characteristic view of the common mode filter of FIG. 2.

FIG. 5 is a power distribution characteristic view of the common mode filter of FIG. 2.

FIG. 6 is a power distribution characteristic view of the common mode filter of FIG. 2.

FIG. 7 is a planar view of an essential part of the common mode filter of FIG. 2 according to another embodiment of the present invention.

FIG. 8 is a transmission characteristic view of the common mode filter of FIG. 7.

FIG. 9 is a transmission characteristic view of the common mode filter of FIG. 7.

FIG. 10 is a transmission characteristic view of the common mode filter of FIG. 7.

FIG. 11 is a planar view of an essential part of the common mode filter of FIG. 2 according to another embodiment.

FIG. 12 is a transmission characteristic view of the common mode filter of FIG. 11.

FIG. 13 is a transmission characteristic view of the common mode filter of FIG. 11.

FIG. 14 is a transmission characteristic view of the common mode filter of FIG. 11.

FIG. 15 is a planar view of an essential part showing the common mode filter according to another embodiment of the present invention.

FIG. 16 is a transmission characteristic view of the common mode filter of FIG. 15.

FIG. 17 is a transmission characteristic view of the common mode filter of FIG. 15.

FIG. 18 is a power distribution characteristic view of the common mode filter of FIG. 15.

FIG. 19 is a perspective view of an essential part of the common mode filter according to another embodiment of the present invention.

FIG. 20 is a transmission characteristic view of the common mode filter of FIG. 19.

FIG. 21 is a power distribution characteristic view of the common mode filter of FIG. 19.

FIG. 22 is a cross-sectional view showing the common mode filter according to another embodiment of the present invention.

FIG. 23 is a cross-sectional view showing a modified common mode filter of FIG. 22.

FIG. 24 is a perspective view of an essential part of the common mode filter of FIG. 22.

FIG. 25 is a cross-sectional view showing the common mode filter according to another embodiment of the present invention.

FIG. 26 is a circuit view showing a conventional common mode filter.

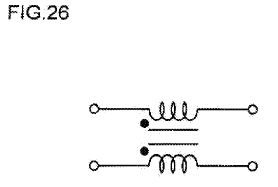

FIG. 27 is a characteristic view of a conventional common mode filter of FIG. 26.

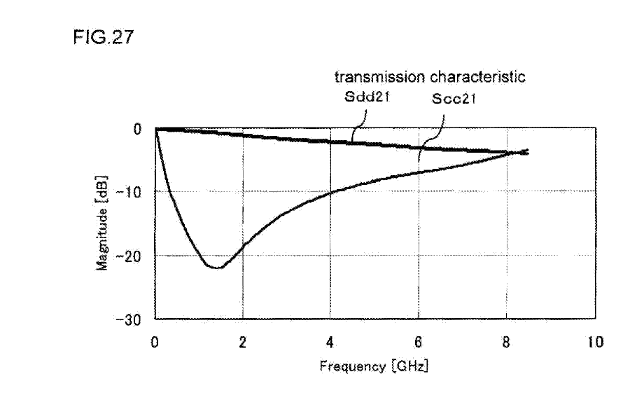

### DESCRIPTION OF PREFERRED EMBODIMENT OF THE INVENTION

Preferred embodiments of the present invention will be described hereafter, with reference to the drawings.

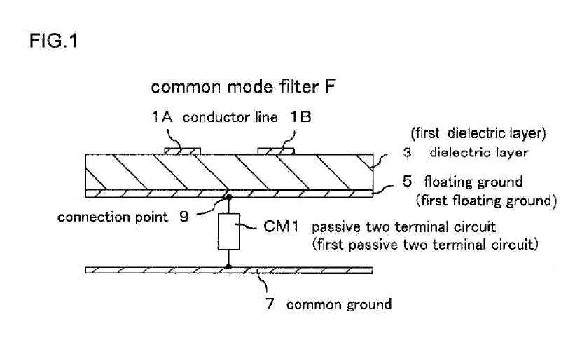

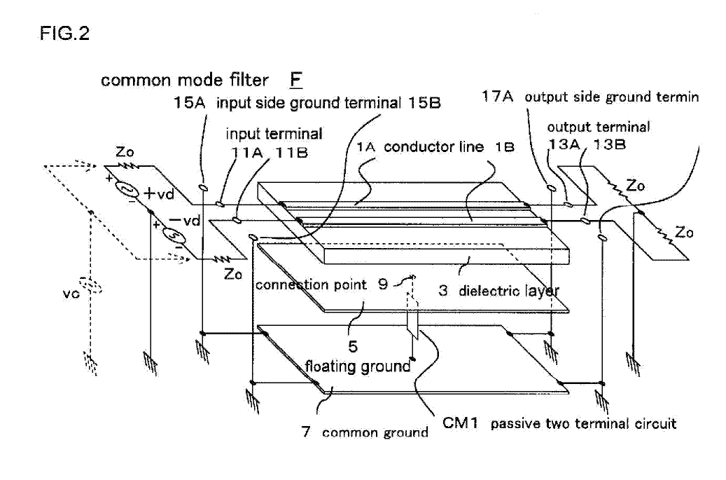

FIG. 1 is a schematic cross-sectional view showing a basic structure of a common mode filter F according to the present invention, and FIG. 2 is an exploded perspective view showing a form of the common mode filter F in perspective. An external circuit is also included in FIG. 2.

In FIG. 1 and FIG. 2, a pair of film-like conductor lines 1A and 1B are formed on one side (upper surface in the figure) of a square, for example, rectangular thin plate-like dielectric layer 3, at an equal interval, separated from each other, and in parallel with each other.

A conductive floating ground 5 is formed on an entire surface of the other side (lower surface in the figure) of the dielectric layer 3, in such a manner as facing the conductor lines 1A and 1B, thus forming a micro strip distributed constant type differential transmission line. A function of the floating ground 5 will be described later.

On the opposite side (lower side in the figure) to the conductor lines 1A and 1B, a common ground 7 having the same shape as the shape of the floating ground 5 is disposed in such a manner as facing the floating ground 5 through a resin substrate or a ceramic substrate not shown. The common ground 7 is connected to an external ground potential.

The external ground potential is a common potential in an electronic device not shown with a common mode filter F mounted thereon.

The dielectric layer 3, the floating ground 5, and a passive two terminal circuit CM1 function as a first dielectric layer, a first floating ground, and a first passive two terminal circuit, in relation to an embodiment as will be described later.

A connection point 9 is formed in a center part in a longitudinal direction of the conductor lines 1A and 1B, being a center between the conductor lines 1A and 1B on the floating ground 5. The passive two terminal circuit CM1 composed of passive circuit elements, is directly connected to the connection point 9 and the center part of the common ground 7, to thereby form the common mode filter F of the present invention.

As the passive circuit elements forming the passive two terminal circuit CM1, inductor, capacitance, resistance, or a combination of them, or a short circuited line can be considered.

Only the passive two terminal circuit CM1 is connected to the floating ground 5 at the connection point 9, and a terminating resistance is not connected to the floating grounds. Therefore, the conductor lines 1A, 1B, the dielectric layer 3, and the floating ground 5 form a terminating open-circuited line for a common mode signal, and function as a distributed constant line resonator.

The floating ground 5 is combined with the passive two terminal circuit CM1 connected thereto at the connection point 9, to thereby form a composite series resonant circuit, and functions as an attenuation band filter for a high frequency common mode signal by functioning together with the distributed constant line resonator. Details will be described later.

In FIG. 2, designation marks 11A, 11B indicate input terminals of the common mode filter F and are connected to input ports of the conductor lines 1A and 1B, and designation marks 13A, 13B indicate output terminals of the common mode filter F and are connected to output ports of the conductor lines 1A and 1B. Designation marks 15A, 15B indicate input side around terminals and are connected to the vicinity of the input ports of the conductor lines 1A and 1B on the common mode ground 7, and designation marks 17A, 17B are output side ground terminals and are connected to the vicinity of the output ports of the conductor lines 1A and 1B on the common ground 7.

Next, an operation of the aforementioned common mode filter F of FIG. 2 will be described.

In FIG. 2, when differential signals +vd, −vd of a source impedance Zo are inputted to the input terminals 11A, 11B of the common mode filter F from a power source, the differential signals +vd, −vd are propagated through the conductor lines 1A, 1B, and are respectively outputted to a load Zo from the output terminals 13A, 13B.

At this time, the differential signals +vd, −vd of opposite phases are mutually negated and are not flown through the passive two terminal circuit CM1. Namely, in the common mode filter F with a structure of FIG. 2, the passive two terminal circuit CM1 is in an nonexistent state for the differential signal, and is operated simply as a micro strip distributed constant type differential transmission line, even if the passive two terminal circuit CM1 is connected.

Meanwhile, a common mode signal vc of in-phase is inputted to two input terminals 11A, 11B of the common mode filter F, and therefore the common mode signal vc flows through the passive two terminal circuit CM1. Namely, the passive two terminal circuit CM1 functions as an element effective for the common mode signal vc only.

In addition, the passive two terminal circuit CM1 is formed by inductance, capacitance, resistance, or a combination of them, and further is formed by a short circuit, thus forming a composite series resonant circuit together with a distributed constant line resonator formed by the conductor lines 1A, 1B, the dielectric layer 3, and the floating ground 5, and functions as a band-pass filter for a high frequency common mode signal.

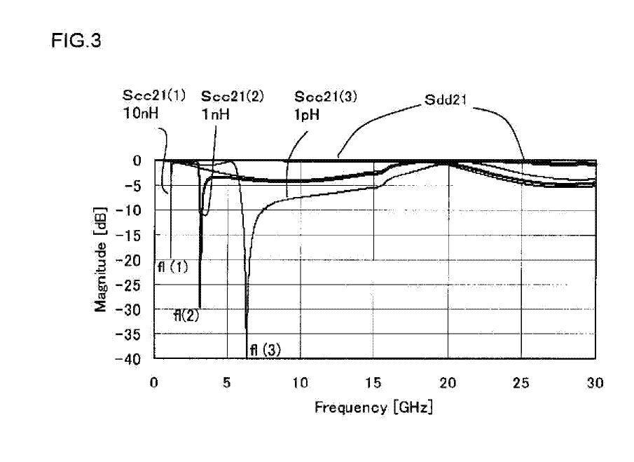

In order to confirm this function, a physical size was designed to generate a propagation delay time of 30 ps of the conductor lines 1A, 1B in the structure of FIG. 2, and electromagnetic field analysis was carried out on the assumption that the passive two terminal circuit CM1 was an ideal inductor, in a state that the passive two terminal circuit CM1 was connected to the common ground 7 from the connection point 9 of the floating ground 5.

Wherein, a length of the floating ground 5 in a direction of the conductor lines was set to 3.4 mm, a width thereof vertical to the conductor lines was set to 1.7 mm, a dielectric constant of the dielectric layer was set to 7.1, and a distance between the floating ground 5 and the common ground 7 was set to 0.5 mm. As a result, the transmission characteristic shown in FIG. 3 was obtained.

In FIG. 3, the common mode filter F of the present invention is considered to be a four terminal circuit wherein input terminals 11A, 11B and input side ground terminals 15A, 15B are set as the input side, and output terminals 13A, 13B and output side ground terminals 17A, 17B are set as the output side. In this case, the transmission characteristic of the differential signal is indicated by Sdd21, and the transmission characteristic of the common mode signal is indicated by Scc21.

A result of the electromagnetic field analysis reveals that the structure of FIG. 2 shows excellent transmission characteristic indicated by Sdd21 for the differential signal, and meanwhile shows the transmission characteristic indicated by Scc21(1) to Scc21(3) for the common mode signal, namely shows a function of the common mode filter for attenuating the common mode signal by forming a resonant circuit, with frequencies f1(1) to f1(3) as attenuation poles.

Wherein, Scc21(1) and f1(1) are the transmission characteristic and resonant frequency when the passive two terminal circuit CM1 is an inductance of 10 nH, Scc21(2) and f1(2) are the transmission characteristic and resonant frequency when the passive two terminal circuit CM1 is an inductance of 1 nH, and Scc21(3) and f1(3) are the transmission characteristic and resonant frequency when the passive two terminal circuit CM1 is an inductance of 1pH. With this structure, it is found that by increasing the inductance, the resonant frequency can be shifted to a lower side, and simultaneously an attenuation bandwidth is narrowed.

This is because when an ideal inductor is connected as the passive two terminal circuit CM1, a total inductor component in the resonant circuit is increased, thereby shifting the resonant circuit to a lower side and increasing Q of the resonant circuit due to a large occupying ratio of the ideal inductor in the resonant circuit, to thereby narrow the attenuation bandwidth.

Next, in order to examine Q of the resonant circuit, similar electromagnetic field analysis was carried out using the passive two terminal circuit CM1 as an ideal resistance element.

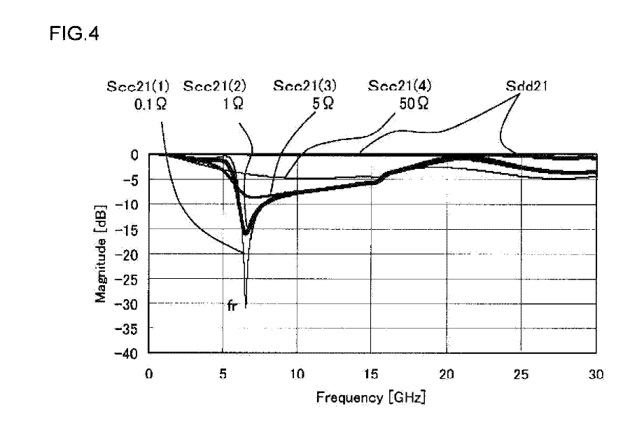

FIG. 4 is a transmission characteristic view of the common mode filter F, when the passive two terminal circuit CM1 is a resistance. The transmission characteristic of the common mode signal is shown by Scc21(1) when a resistance of the passive two terminal circuit CM1 is 0.1Ω, and the transmission characteristic is shown by Scc21(2) when a resistance of the passive two terminal circuit CM1 is 1Ω, and the transmission characteristic is shown by Scc21(3) when a resistance of the passive two terminal circuit CM1 is 5Ω, and the transmission characteristic is shown by Scc21(4) when a resistance of the passive two terminal circuit CM1 is 50Ω.

The transmission characteristic shown by Scc21(1) when a resistance is 0.1Ω, shows a characteristic close to the transmission characteristic (3) when an inductor is 1 pH in FIG. 3, and it is found that both transmission characteristics are close to a short circuited line in an ideal state. Namely, it is found that even in a case that the passive two terminal circuit CM1 is a simple short circuited line, the resonant circuit is formed in the structure of FIG. 2, and a deepest attenuation pole is formed in this case.

As the resistance value of the passive two terminal circuit CM1 is increased, Q of the resonant circuit is decreased, and the attenuation pole becomes gradually shallow. Particularly, the attenuation pole becomes inconspicuous to a level that the characteristic can't be called the resonant characteristic any more when a resistance of the passive two terminal circuit CM1 is 50Ω. Namely, Q of the resonant circuit is decreased by enter of the resistance into the resonant circuit, and energy is lost due to the resistance.

Further, ratios of transmission and reflection of the entered common mode signal power were examined, when the passive two terminal circuit CM1 is an inductance of 1 pH, and when the passive two terminal circuit CM1 is a resistance of 50Ω.

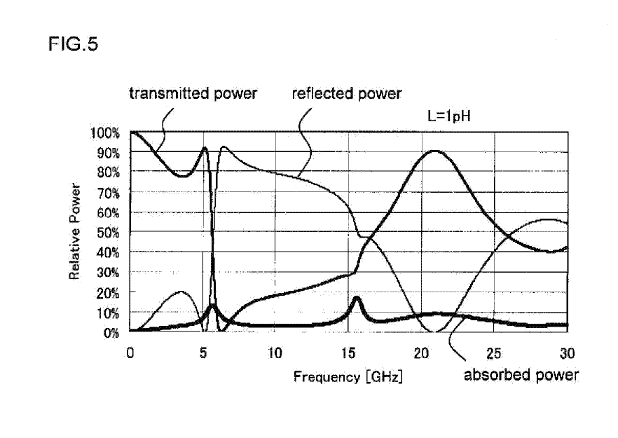

FIG. 5 shows the transmission ratio and the reflection ratio of the common mode signal power in each frequency, with the common mode signal power entered into the common mode filter F set as 100%, when the passive two terminal circuit CM1 is an inductance of 1 pH. Wherein, the power remained after subtracting a transmitted power and a reflected power from a total power, is the common mode signal power absorbed and consumed by the common mode filter F, and this power is defined as an absorbed power.

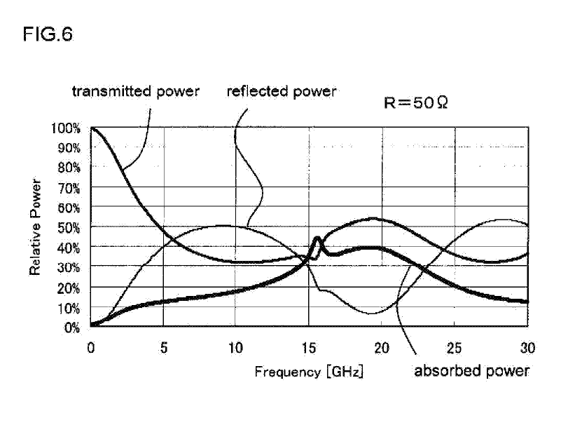

Further, FIG. 6 shows the ratio of the transmitted power, the ratio of the reflected power, and the ratio of the absorption power in each frequency, with the common mode signal power entered into the common mode filter F set as 100%, when the passive two terminal circuit CM1 is a resistance of 50Ω.

As is clarified from FIG. 5 and FIG. 6, although the absorption power is generated when the passive two terminal circuit CM1 is a resistance, almost no absorption power is generated when the passive two terminal circuit CM1 is an inductance, and most of the power not passing thorough the common mode filter F is reflected. In addition, since the inductance is close to the ideal short circuited line, most of the power not passing through the common mode filter F is reflected even in a case that the passive two terminal circuit CM1 is the short circuited line.

As described above, analysis is carried out on the assumption that the passive two terminal circuit CM1 is an ideal inductor and an ideal resistance. Then, in order to obtain a deepest attenuation pole in the structure of FIG. 2, it is found that the passive two terminal circuit CM1 preferably has smallest values of both the inductance and resistance, namely, short circuited line is suitable.

The short circuited line is not simply formed as the short circuited line, but forms a series resonant circuit for a high frequency common mode signal, together with the distributed constant line resonator.

Incidentally, there is a high possibility that the short circuited line for actually forming a product, is formed by a conductive via that connects electrodes, etc., so as to pass through front and rear surfaces of a substrate. However, the via has a limited sectional area, and therefore there is almost no case that the connection is made by a point contact at the connection point 9 as described in the above analysis.

Therefore, electromagnetic field analysis was carried out using the passive two terminal circuit CM1 as a square via.

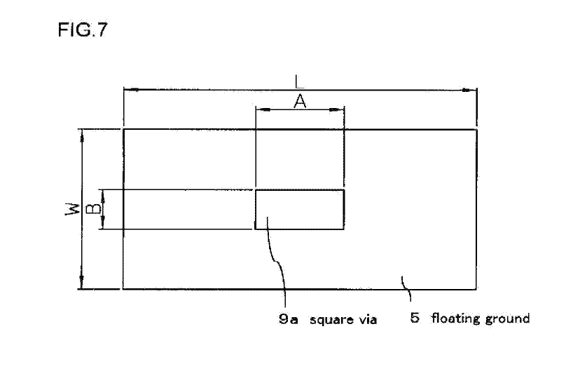

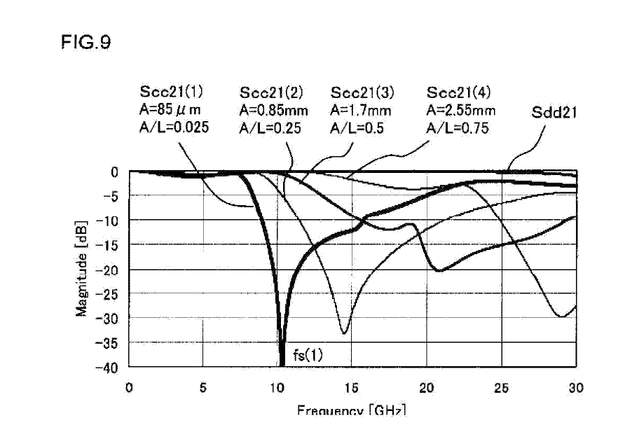

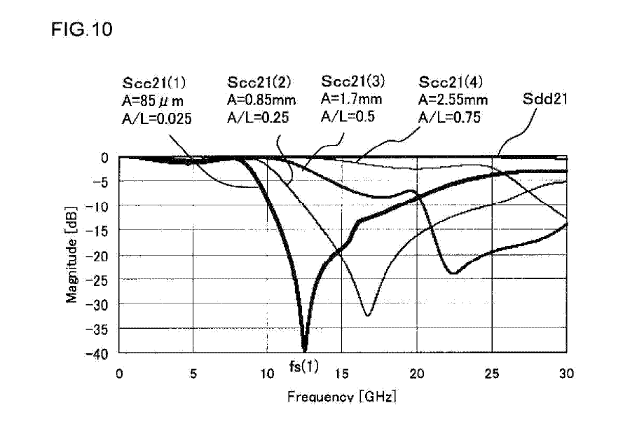

FIG. 7 shows a square via 9a and the floating ground 5. A width of the via 9a in a direction of the conductor lines 1A, 1B is set to A, and a width thereof in a direction orthogonal to these conductor lines is set to B, a length of the floating ground 5 in the direction of the conductor lines is set to L, and a width of the floating ground 5 in a direction vertical to these conductor lines is set to W, and the ratio of them A/L and B/W are varied, to thereby obtain the transmission characteristic of the common mode signal. Results thereof are shown in FIG. 9 to FIG. 10. Each curve has a characteristic shown in table 1.

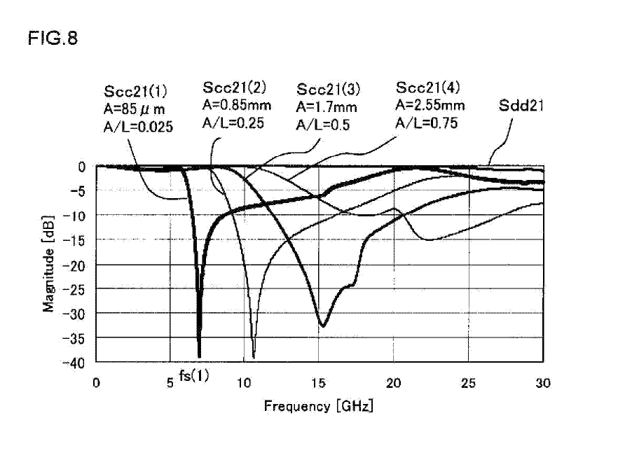

TABLE 1

| Figure | Curve name | Dimension A | A/L | Dimension B | B/W |
|---|---|---|---|---|---|
| FIG. 8 | Scc21 (1) | 85 μm | 0.025 | 85 μm | 0.0 5 |
| | Scc21 (2) | 0.85 mm | 0.25 | | |
| | Scc21 (3) | 1.7 mm | 0.5 | | |
| | Scc21 (4) | 2.55 mm | 0.75 | | |
| FIG. 9 | Scc21 (1) | 85 μm | 0.025 | 0.85 mm | 0.5 |
| | Scc21 (2) | 0.85 mm | 0.25 | | |
| | Scc21 (3) | 1.7 mm | 0.5 | | |
| | Scc21 (4) | 2.55 mm | 0.75 | | |
| FIG. 10 | Scc21 (1) | 85 μm | 0.025 | 1.7 mm | 1.0 |
| | Scc21 (2) | 0.85 mm | 0.25 | | |
| | Scc21 (3) | 1.7 mm | 0.5 | | |
| | Scc21 (4) | 2.55 mm | 0.75 | | |

Wherein L = 3.4 mm, and W = 1.7 mm.

Note that designation mark fs(1) indicates a resonant frequency in a case of A=85 μm in each figure. Further, Sdd21 indicates a differential signal transmission characteristic, and excellent characteristics are shown in all figures.

According to these figures, it is found that as dimension A and dimension B of via 9a become larger, the attenuation pole becomes shallow, and the resonant frequency is also shifted to a higher side, and a broader transmission bandwidth of the common mode signal is obtained. However, a deep attenuation pole and a broad attenuation bandwidth can be obtained at the ratio of A/L≦0.25, irrespective of the value of B.

Further, in a case of B=85 excellent Scc 21 characteristic can be obtained in a range of A/L≦0.5.

Meanwhile, the attenuation pole becomes shallow at the ratio of A/L=0.75, irrespective of the value of B, and the resonant frequency is also shifted to a higher side, thereby showing a hardly practicable characteristic of the common mode filter. The aforementioned contents are summarized as follows.

A/L≦0.25: Surely functioning as the common mode filter

A/L≦0.5: Possibly functioning as the common mode filter

A/L≧0.75: Hardly functioning as the common mode filter

Therefore, it can be said that the ratio of A/L≦0.5 is a minimum condition of a practical use of the common mode filter.

In actual laminated components, in order to form the via 9a, the following technique is used. Namely, a through hole is formed on a dielectric layer by a small diameter drill or punching, or laser, etc., and this through hole is filled with a conductive material. Therefore, it is inconceivable that one via 9a has a large sectional area exceeding the above-described conditions.

Therefore, the structure of FIG. 2 functions as the common mode filter F, provided that the passive two terminal circuit CM1 is connected at only one place of the connection point 9 such as a via 9a.

Next, a case that a plurality of passive two terminal circuits CM1 are connected in a wide range of the floating ground, will be considered.

Therefore, it is examined whether or not the condition of A/L≦0.5 can be applied even when a plurality of passive two terminal circuits CM1 are connected, so that the common mode filter F is put into practical use, wherein the aforementioned square via is formed.

An analysis result obtained by the aforementioned analysis when the square via is used, is equivalent to a case that an area of the square via 9a is filled with innumerable thin short circuited lines. Therefore, variation of the conditions will be considered, by reducing the density of the short circuited lines from the innumerable short circuited lines, wherein the conditions are necessary for the common mode filter F being put into practical use.

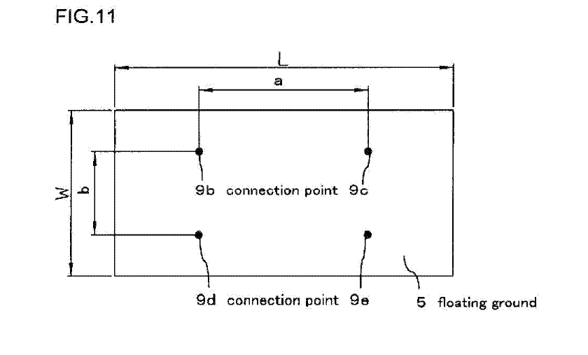

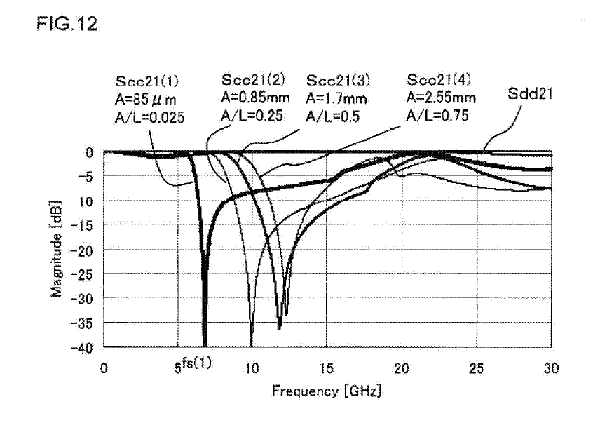

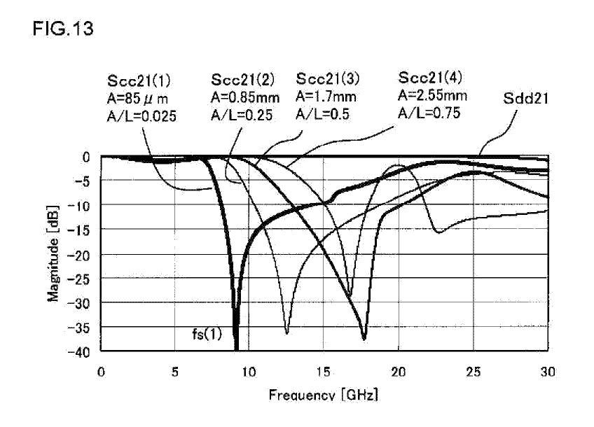

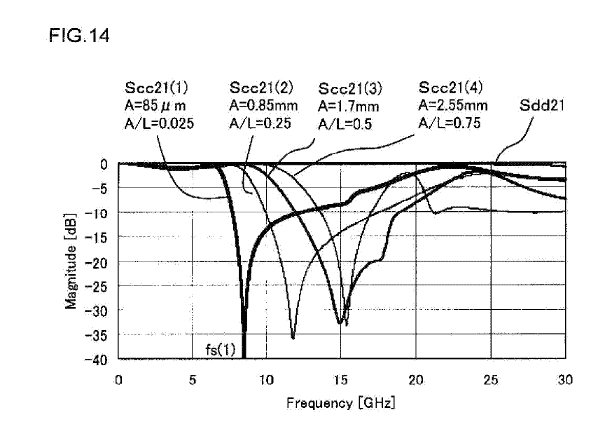

Therefore, as shown in FIG. 11, connection points 9b to 9e were arranged in a corner portion of the square, and an ideal short circuited line was connected to each connection point as the passive two terminal circuit CM1, wherein a distance between connection points in the direction of the conductor lines was defined as a, and a distance between connection points in a direction vertical to the conductor lines was defined as b, and electromagnetic field analysis similar to that of FIG. 7 was carried to thereby obtain a minimum number of short circuited lines for approximating the square via. Results thereof are shown in FIG. 12 to FIG. 14.

FIG. 12 to FIG. 14 are compared with FIG. 8 to FIG. 10, and it is found that a deep attenuation pole can be obtained even at the ratio of a/L=0.75 irrespective of the value of b, and the common mode filter F can be put into practical use without doubt at the ratio of 1/L≦0.75.

As described above, in order to arrange a plurality of short circuited lines for approximating the square via 9a, the condition necessary for the practical use of the common mode filter F is as follows.

Four short circuited lines are arranged in the corner portion of the square: a/L≦0.75
A square area is filled with a plurality of short circuited lines: a/L≦0.5

It is estimated that as the number of short circuited lines is increased, an upper limit of a/L is lowered to 0.5 from 0.75.

Accordingly, if the short circuited lines are designed to satisfy at least a/L≦0.5, the condition necessary for the practical use of the common mode filter F is satisfied.

Further, although not shown, the condition necessary for the practical use of the common mode filter F is also a/L≦0.5 when the via 9a is formed into a large column with a diameter of a, and the condition necessary for the practical use of the common mode filter F is also a/L≦0.5 when a plurality of short circuited lines are used to approximate the large column.

As described above, the passive two terminal circuit is not limited to the via and the short circuited line, and includes inductor, capacitor, and resistor, etc., and even in a case that a plurality of them are arranged at random, the condition necessary for the practical use of the common mode filter is that a distance between farthest two connection points in the direction of the conductor lines 1A, 1B is ½ or less of a length of the floating ground 5 in the direction of the conductor lines.

Note that widths of the floating ground 5 and the common ground 7 are set to the same dimensions for the convenience of drawing a figure in FIG. 1 and FIG. 2. However, the attenuation characteristic of the common mode signal can be varied by increasing/decreasing the width of the common ground 7 with respect to the width of the floating ground 5. The relation between both widths may be arbitrarily increased/decreased, in accordance with a target characteristic.

Further, although not shown, the resonant frequency is shifted to a lower side by moving the connection point 9 from the center to an end of the floating ground 5 in the direction of the conductor lines. Therefore, the resonant frequency can be finely adjusted.

Further, although not shown, the resonant frequency is decreased by increasing the length of the conductor lines and setting a delay time larger than 30 ps. Namely, in order to set a further lower resonant frequency, it is most effective to set the delay time to be large.

Next, another embodiment of the common mode filter F of the present invention will be described.

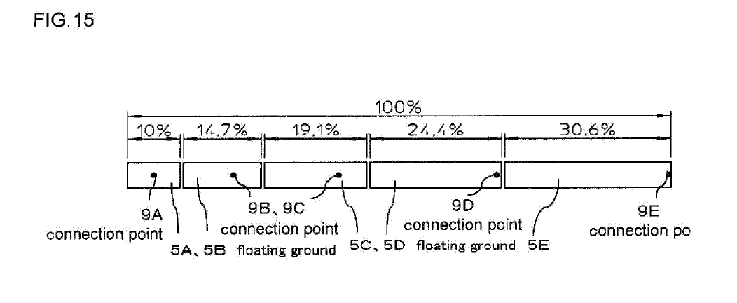

FIG. 15 is an explanatory view for describing an essential part of the common mode filter F according to another embodiment of the present invention and shows a structure in which the floating ground 5 is divided into a plurality of parts.

A basic structure of the common mode filter F shown in FIG. 15 is the same as the structure of FIG. 2. However, there is a difference in a position of the connection point between the floating ground 5 and the passive two terminal circuit CM1 connected to the floating ground 5. Other structure is the same as the structure of FIG. 2.

Namely, FIG. 15 shows a structure in which only the floating ground 5 is extracted and shown in the micro strip distributed constant type differential transmission line having the conductor lines 1A, 1B wherein the delay time is set to 150 ps, and the lengths of the conductor lines 1A, 1B and the length of the floating ground 5 are increased, as the delay time is increased.

According to this structure, the floating ground 5 is divided into five divided floating grounds 5A, 5B, 5C, 5D, and 5E with different lengths in a length direction of the floating ground 5, wherein the passive two terminal circuit CM1 is connected between each of the five divided floating grounds 5A to 5E, and the common ground 7 one by one (the common ground 7 and the passive two terminal circuit CM1 are not shown).

A dividing method is as follows: divided floating ground 5A: 10%, 5B: 14.7%, 5C: 19.1%, 5D: 24.4%, 5E: 30.6% from the left of FIG. 15, with a total length of the floating ground 5 defined as 100%.

The divided floating grounds 5A to 5E are divided by gaps with equal intervals from each other, and a total intervals of the gaps is 1.2%.

Connection points 9A, 9B, 9C, 9D, and 9E are formed between each of the floating grounds 5A to 5E, and each of the passive two terminal circuits CM1, wherein the connection point 9A of the floating ground 5A at the left end in the figure is located in the center portion of the ground 5A, and the connection point 9E of the ground 5E at the rightmost end is set at the rightmost end, and connection points 9B to 9D are set at positions moved to the right side sequentially from the center portion of the floating grounds 5B and 5D between the floating ground 5A and the floating ground 5E.

With this structure, the resonant frequency is decreased as the length of each conductor lines 1A, 1B is increased, and in addition, the floating ground 5 is divided to thereby divide a resonance point, and therefore the attenuation of the common mode signal can be easily obtained in a broader frequency range.

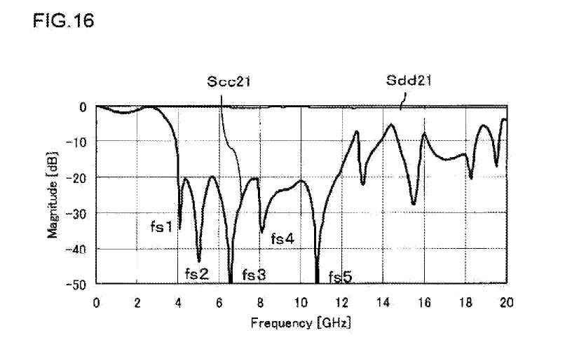

FIG. 16 is a characteristic view in a case that the passive two terminal circuit CM1 composed of short circuited lines entirely is connected to the connection points 9A to 9E, wherein attenuation pole fs1 has a frequency of 4.1 GHz, fs2 has a frequency of 5.0 GHz, fs3 has a frequency of 6.6 GHz, fs4 has a frequency of 8.1 GHz, and fs5 has a frequency of 10.8 GHz.

As a result, the transmission characteristic of the common mode signal shows a U-shaped characteristic in a range from 4 GHz to 11.8 GHz, and an attenuation value of −20 dB or more can be obtained.

In FIG. 16, heights of peaks between five attenuation poles of fs1 to fs5 are set to be a uniform value of 20 dB. These characteristics are obtained by dividing the floating ground 5 shown in FIG. 15 and by setting the positions of each of the two terminal circuit connection points 9A to 9E in the divided grounds.

Thus, in the structure of FIG. 15, by dividing the floating ground 5 into five divided floating grounds 5A to 5E, and by connecting thereto passive two terminal circuits CM1 one by one, there is an advantage that a plurality of different resonant frequencies can be obtained, and the attenuation of the common mode signal in a broader bandwidth can be obtained.

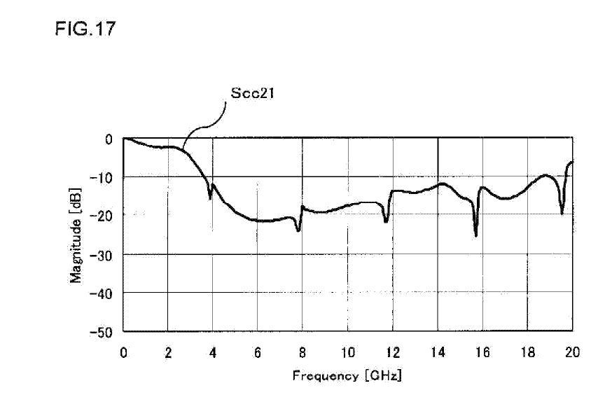

Further, although not specifically shown, a part or all of the passive two terminal circuits CM1 connected to the connection points 9A to 9E of the divided floating grounds 5A to 5E shown in FIG. 15 can be resistances of about several Ω to several tens of Ω, and FIG. 17 shows a characteristic view thereof.

In addition, it is also acceptable to connect the passive two terminal circuit CM1 to all or any one of the divided floating grounds 5A to 5E.

FIG. 17 shows the characteristic that all passive two terminal circuits CM1 are set as a resistance of 10Ω, and valleys of the attenuation poles become shallow as the value of Q of the passive two terminal circuit CM1 is decreased by insertion of the resistance into the resonant circuit, and a head portion between the attenuation poles becomes reversely lower.

As a result, the attenuation characteristic of the common mode signal shows a U-shape, and the attenuation in the vicinity or 4 GHz is deteriorated to about −12 dB, and meanwhile, the peak between attenuation poles becomes lower in the bandwidth of 12 GHz or more, so that a uniform attenuation characteristic can be obtained in a broader bandwidth.

From a viewpoint of the purpose of use, the transmission characteristic of the common mode signal required for the common mode filter F of the present invention is as follows. Namely, an average attenuation value, namely a constant attenuation in a broader frequency bandwidth, can be obtained, rather than obtaining a deep attenuation in a specific attenuation pole frequency.

As a more important point, as shown in FIG. 6, a part of an attenuated common mode signal is absorbed by resistance and a reflected power can be reduced, by using the resistance of the passive two terminal circuit CM1.

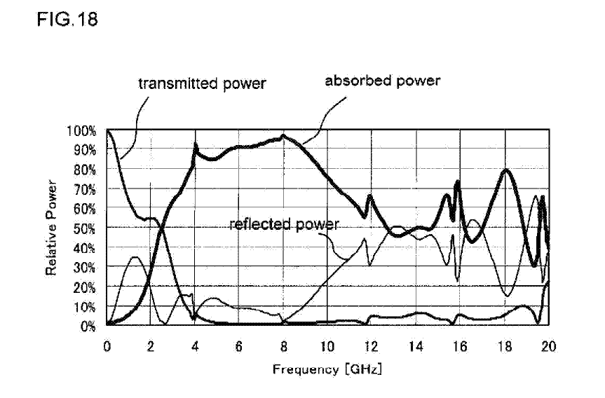

Therefore, FIG. 18 shows a state that the characteristic of FIG. 17 is expressed by the ratio of the transmitted power, reflected power, and absorption power. FIG. 18 shows a state that a major part of the power is absorbed inside, and the reflected power is suppressed.

In order to obtain such a state, it may be designed that a resistance of a proper value is connected in series to the inductor or the short circuited line in the passive two terminal circuit CM1 instead of obtaining a deep attenuation which is simply obtained by the inductance or the short circuited line as described above, to thereby decrease the value of Q of the resonant circuit and cause absorption loss of the common mode to occur by the resistance. Thus, a kind of a damping effect can be obtained, and a constant attenuation curve of a broad frequency can be obtained, and also the transmission characteristic of the common mode signal can be improved.

In the above description, the conductor lines 1A and 1B are described as straight lines. However, the conductor lines 1A and 1B may be meander lines.

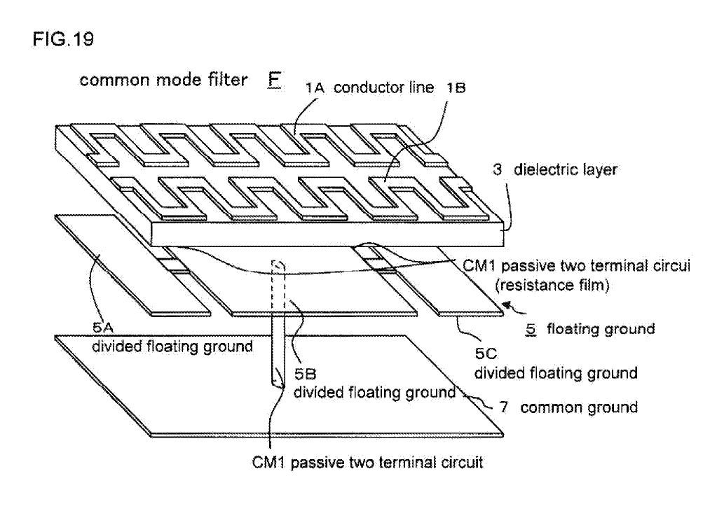

Also, in the above description, all passive two terminal circuits CM1 are connected between the floating ground 5 and the common around 7. However, all passive two terminal circuits CM1 may also be connected between all adjacent divided floating grounds 5A to 5E, or between any one of them. An example thereof is shown in FIG. 19.

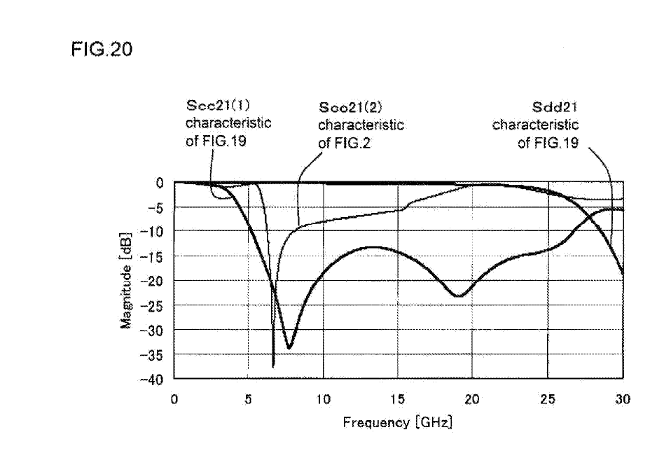

FIG. 19 shows a state that the conductor lines 1A and 1B are set as meander lines while maintaining a dimension of the floating ground 5 as it is in FIG. 2, and the floating ground 5 is divided into the divided floating ground 5A of one cycle, the divided floating ground 5B of three cycles, and the divided floating ground 5C of one cycle, so as to match the return cycles of the conductor lines 1A and 1B. Only the divided floating ground 5B in the center has the via with a diameter of 85 μm connected between the divided floating ground 5B and the common ground 7 in the passive two terminal circuit CM1, and the divided floating grounds 5A and 5C of both sides are partially connected to the floating ground 5B in the center through a resistance film of the passive two terminal circuit. The resistance value of the resistance film is 20Ω. A result of an electromagnetic field analysis with this structure is shown in FIG. 20.

In FIG. 20, Scc21(1) indicates a common mode signal transmission characteristic in the structure of FIG. 19, Scc21(2) indicates a common mode signal transmission characteristic when the passive two terminal circuit CM1 includes the via with diameter of 85 μm in FIG. 2, and Sdd21 indicates a differential signal transmission characteristic in the structure of FIG. 19.

According to this structure, a broad common mode attenuation bandwidth can be obtained by dividing the floating ground 5 into the divided floating grounds 5A to 5C, while the floating ground 5 of FIG. 19 has the same outer dimension as that of the floating ground 5 of FIG. 2, thus considerably improving the attenuation characteristic. Further, Sdd21 is the transmission characteristic with practically no problem, although large attenuation is observed at 25 GHz or more.

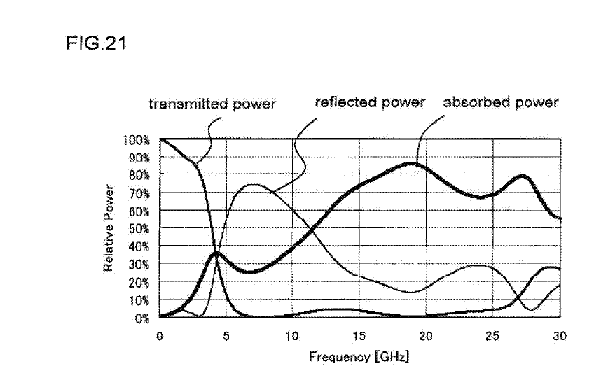

FIG. 21 shows a state that the ratio of the transmitted power, the reflected power, and the absorption power is obtained regarding the common mode signal power having the transmission characteristic Scc21(1) of FIG. 20. Thus, it is found that the common mode power can be absorbed even in a case that the resistance of the passive two terminal circuit CM1, is connected between the divided floating grounds 5A to 5C.

As described above, explanation is given for a structure in which the common ground 7 faces the floating ground 5. However, the present invention is not limited to this structure in which the common ground 7 faces the floating ground 5.

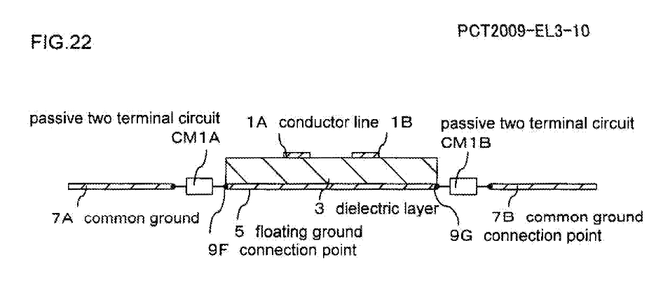

For example, FIG. 22 shows an example of the structure in which similar common grounds 7A and 7B are disposed at the right and left sides of the floating ground 5 on the same plane as the floating ground 5.

In this structure, right and left opposed ends of the floating ground 5 are connection points 9F and 9G, and the passive two terminal circuit CM1A is connected between the connection point 9F and the common ground 7A, and another passive 2 terminal circuit CM1B is connected between the connection point 9G and the common ground 7B.

Namely, the other end of the passive two terminal circuit CM1A with one end connected to the floating ground 5, is connected to the common ground 7A, and the other end of the passive two terminal circuit CM1B with one end connected to the floating ground 5 at the opposed position, is connected to the common ground 7B.

Note that the common grounds 7A and 7B at input/output sides are connected to the external ground, and the other structure is the same as the structure of FIG. 2.

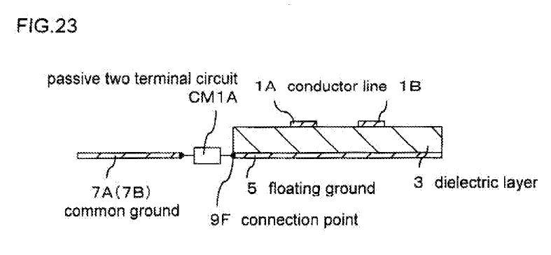

Further, FIG. 23 shows a structure in which the passive two terminal circuit CM1A or CM1B is connected to only one of the common grounds 7A and 7B in the structure of FIG. 22, and the common ground 7B or 7A, and the passive two terminal circuit CM1B or CM1A are omitted.

Namely, only in the passive two terminal circuit CM1A, one end is connected to the floating ground 5, and the other end is connected to the common ground 7A.

Note that FIG. 23 shows the same structure as the structure of FIG. 22 in which one of the passive two terminal circuits CM1A and CM1B is inserted as a resistance having infinite resistance values.

FIG. 23 shows a structure in which the common mode signal equally applied to the conductor lines 1A and 1B returns to the common ground 7A. However, a return path from the conductor line 1B is longer than the conductor line 1A, and therefore the common mode signal transmission characteristic of the conductor line 1A is slightly different from the common mode signal transmission characteristic of the conductor line 1B.

However, it is the attenuation of an absolute value of amplitude of the common mode signal, that is required for the common mode filter F. Originally, a frequency component and amplitude of the common mode signal transmitted through the conductor line 1A and the conductor line 1B are not completely equal to each other. Therefore, even if there is a slight unbalance in the characteristic, an influence by the unbalance can be ignored, provided that the absolute value of the amplitude of the common mode signal is small.

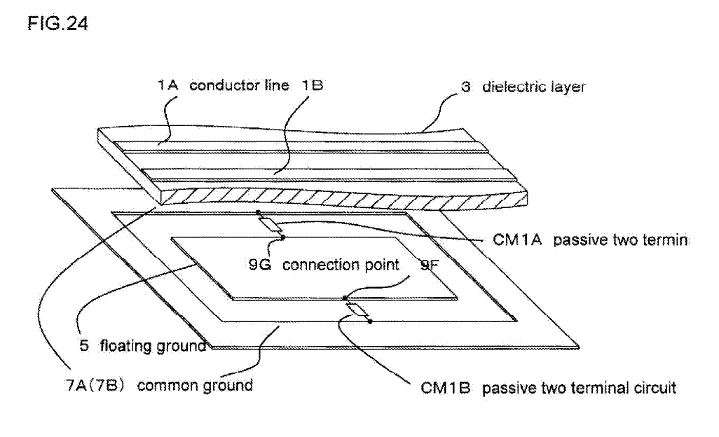

FIG. 24 is an exploded perspective view showing the structure of FIG. 22 in perspective, and shows the common grounds 7A and 7B formed into plate-like frames. Although not shown, the transmission characteristic of the common mode signal similar to the structure of FIG. 2 can be obtained.

Further, when there are a plurality of passive two terminal circuits CM1A and CM1B, it is confirmed by the electromagnetic field analysis, that the function of the common mode filter can be maintained, provided that a distance between farthest two points of a plurality of connection points 9F and 9F and the connection points 9G and 9G is ½ or less of the length of the floating ground 5 in the direction of the conductor lines.

Further, in a case that the passive two terminal circuits CM1A and CM1B are short circuited lines (connection piece, etc.) having widths, it may be interpreted that the width of the connection piece is equal to the distance between the farthest two points of the connection points 9F and 9F, or the connection points 9G and 9G.

Therefore, in the structure of FIG. 24 as well, the case is not limited to the connection piece and the short circuited line, and even in a case that a plurality of passive two terminal circuits are arranged, it can be said that the condition necessary for the practical use of the common mode filter F is as follows: the distance between the furthest two connection points in the direction of the conductor lines, out of the connection points that exist in the passive two terminal circuit, is ½ or less of the length of the floating ground in the direction of the conductor lines.

As described above, explanation is given for an example that the common mode filter F of the present invention is the micro strip distributed constant type differential transmission line, being the distributed constant type differential transmission line.

However, the common mode filter F of the present invention may be a distributed constant type transmission line with a pair of conductor lines having facing grounds with a dielectric body interposed between them. Namely, a structure using a strip distributed constant type differential conductor line is also acceptable.

Next, explanation will be given for the structure using the strip distributed constant type differential conductor line as the common mode filter F.

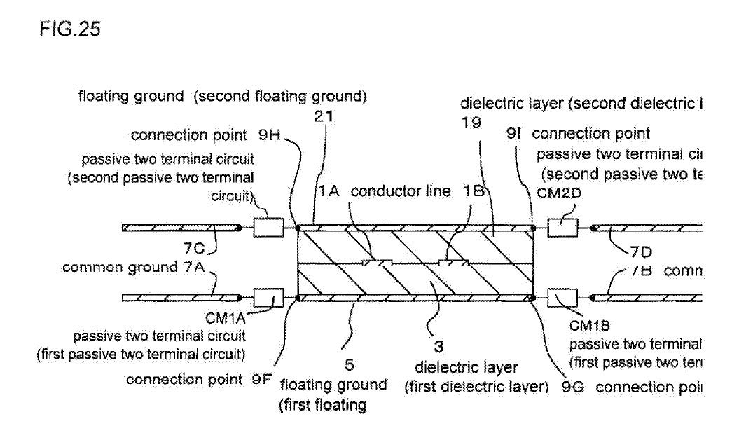

FIG. 25 is a cross-sectional view showing the common mode filter F of the present invention using the strip distributed constant type differential conductor line.

Namely, a dielectric layer (second dielectric layer) 19 similar to the dielectric layer 3 (first dielectric layer) is formed on the dielectric layer 3 shown in FIG. 22, to thereby interpose the conductor lines 1A and 1B between the dielectric layer 3 and the dielectric layer 19. In addition, a floating ground (second floating ground) 21 similar to the floating ground (first floating ground) 5 is formed all over an outer surface of the dielectric layer 19, and common grounds 7C and 7D similar to the common grounds 7A and 7B are disposed at the right and left sides of the floating ground 21 on the same plane as the floating ground 21.

Further, right and left opposed ends of the floating ground 21 are connection points 9H and 9I, and the passive two terminal circuit CM2C is connected between the connection point 9H and the common ground 7C, and another passive two terminal circuit CM2D is connected between the connection point 9I and the common ground 7D, to thereby form the common mode filter F. The other structure is the same as the structure of FIG. 22.

Then, the floating ground (second floating ground) 21 and the passive two terminal circuits (second passive two terminal circuits) CM2C, CM2D of the common mode filter F shown in FIG. 25 can be formed using the aforementioned FIG. 1, FIG. 2, FIG. 7, FIG. 11, FIG. 15, FIG. 19, FIG. 23, and FIG. 24, similarly to the floating ground (first floating ground) 5 and the passive two terminal circuits (first passive two terminal circuits) CM1, CM1A, CM1B.

In the above-described embodiments, in a case that there are a plurality of passive impedance two terminal circuits CM1 used in one common mode filter F, explanation is given for a case that all same kinds of passive elements are used, or a combination of the resistance and the short circuited line is used.

Namely, FIG. 11 shows a case that two or four short circuited lines are used, and FIG. 15 shows a case that five short circuited lines and five resistances are used, and FIG. 19 shows a case that one short circuited line and two resistances are used.

However, in the present invention, the inductance, the short circuited line, the capacitance, and the resistance can be used by arbitrarily combining them as the first passive two terminal circuit CM1 and the second passive two terminal circuit CM2 in one common mode filter F.

Further, the common mode filter F of the present invention can be formed not only as a simple component but also as a component together with other functional component.

For example, in a case that the common mode filter F of the present invention is assembled into a differential delay line as an electronic component, when there is a delay time of the differential delay line more than the delay time required for the common mode filter F, the divided floating grounds of the number required by the portion of the required delay time are formed to connect the passive two terminal circuit CM1, and the remaining portion may be formed as the floating ground 5 with the passive two terminal circuit CM1 not connected thereto.

Further, as an example of the distributed constant type differential conductor line having the floating ground 5 facing a pair of conductor lines 1A and 1B with the dielectric layer 3 interposed between them, only two kinds of lines such as the micro strip line and the strip line are shown.

However, sectional shapes of the pair of conductor lines need not to be planar rectangular shapes arranged on the same plane, and further the ground facing the pair of conductor lines with the dielectric layer interposed between them need not to be a plane, based on a theoretical concept of the present invention.

For example, even in a case that a twist pair coated copper wire is covered with an insulating material that functions as a dielectric body and a surrounding thereof is covered with a conductor which is a ground, this ground can be formed as the floating ground 5, and the effect of the present invention can be realized by dividing this floating ground 5 into divided floating grounds.

Further, in the present invention, analysis is made on the assumption that a pair of conductor lines 1A and 1B have the same delay time. However, time difference may be provided between the conductor lines 1A and 1B. Thus, when a phase shift is generated between differential signals, an effect of correcting the phase shift and attenuating the common mode signal can be simultaneously obtained by the common mode filter F.

### DESCRIPTION OF SINGS AND NUMERALS

1A, 1B: Conductor line
3: Dielectric layer (first dielectric layer)
5: Floating ground (first floating ground)
5A, 5B, 5C, 5D, 5E: Divided floating ground (first floating ground)
7, 7A, 7B: Common ground
9, 9A, 9B, 9C, 9D, 9E, 9b, 9c, 9d, 9e:
Connection point
9a: Via (connection point)
11A, 11B: Input terminal
13A, 13B: Output terminal
15A, 15B: Input side ground terminal
17A, 17B: Output side ground terminal
19: Dielectric layer (Second dielectric layer)
21: Floating ground (second floating ground)
CM1, CM1A, CM1B: Passive two terminal circuit (first passive two terminal circuit)
CM2C, CM2D Passive two terminal circuit (second passive two terminal circuit)
CM2 Passive two terminal circuit (second passive two terminal circuit)
F Common mode filter

1-13. (canceled)

14. A common mode filter comprising:
a pair of conductor lines formed on a first dielectric layer and configured to transmit a differential signal;
a first floating ground separated from an external ground potential, formed to face the conductor lines with the first dielectric layer interposed between them, and configured to form a distributed constant-type differential transmission line for transmitting the differential signal, together with the conductor lines; and
one or more first passive two terminal circuit connected between the first floating ground and the external ground potential, wherein a width of the connection points connected to the first floating ground or a distance between farthest two points in a direction of the conductor lines for the distance between the plurality of connection points connected to the first floating ground, is ½ or less of a length of the first floating ground in the direction of the conductor lines,
wherein the first passive two terminal circuit is composed of inductance, capacitance, resistance, or a combination of them as a passive element, or a short circuited line.

15. The common mode filter according to claim 14, wherein the first floating ground is divided into a plurality of parts in a length direction of the conductor lines, and the first passive two terminal circuit is connected between all of the divided floating grounds or any one of them, and the external ground potential.

16. The common mode filter according to claim 14, comprising a common ground which is disposed at right and left positions of the conductor lines or at one of them with the first passive two terminal circuit disposed between them on the same plane as the first floating ground, and connected to the external ground, wherein the first passive two terminal circuit is connected to at least one of the right and left positions between respective end portions of the first floating ground and the common ground.

17. The common mode filter according to claim 15, wherein the divided first floating grounds are formed so that the first passive two terminal circuit is connected between all or a part of the adjacent divided floating grounds.

18. The common mode filter according to claim 14, comprising a second floating ground separated from the external ground potential, formed to face the conductor lines with a second dielectric layer interposed between them, and configured to form a distributed constant-type differential transmission line.

19. The common mode filter according to claim 18, comprising one or more second passive two terminal circuits connected between the second floating ground and the external ground potential and composed of inductance, capacitance, resistance, or a combination of them as passive elements.

20. The common mode filter according to claim 19, wherein the second floating ground is divided into a plurality of parts in a length direction of the conductor lines, and the second passive two terminal circuit is connected between all or any one of the divided floating grounds, and the external ground potential.

21. The common mode filter according to claim 19, comprising a common ground which is disposed at right and left positions of the conductor lines or at one of them with the second passive two terminal circuit disposed between them on the same plane as the second floating ground, and connected to the external ground, wherein the second passive two terminal circuit is connected to at least one of the right and left positions between respective end portions of the second floating ground and the common ground on the same plane as the second floating ground.

22. The common mode filter according to claim 20, wherein the divided second floating grounds are formed so that the second passive two terminal circuit is connected between all or a part of the adjacent divided floating grounds.

23. The common mode filter according to claim 20, wherein both the divided first floating grounds and the divided second floating grounds are formed so that the second passive two terminal circuit is connected between all or a part of the adjacent divided floating grounds.

24. The common mode filter according to claim 15, comprising a common ground which is disposed at right and left positions of the conductor lines or at one of them with the first passive two terminal circuit disposed between them on the same plane as the first floating ground, and connected to the external ground, wherein the first passive two terminal circuit is connected to at least one of the right and left positions between respective end portions of the first floating ground and the common ground.

25. The common mode filter according to claim 16, wherein the divided first floating grounds are formed so that the first passive two terminal circuit is connected between all or a part of the adjacent divided floating grounds.

26. The common mode filter according to claim 15, comprising a second floating ground separated from the external ground potential, formed to face the conductor lines with a second dielectric layer interposed between them, and configured to form a distributed constant-type differential transmission line.

27. The common mode filter according to claim 20, comprising a common ground which is disposed at right and left positions of the conductor lines or at one of them with the second passive two terminal circuit disposed between them on the same plane as the second floating ground, and connected to the external ground, wherein the second passive two terminal circuit is connected to at least one of the right and left positions between respective end portions of the second floating ground and the common ground on the same plane as the second floating ground.

28. The common mode filter according to claim 21, wherein the divided second floating grounds are formed so that the second passive two terminal circuit is connected between all or a part of the adjacent divided floating grounds.

29. The common mode filter according to claim 21, wherein both the divided first floating grounds and the divided second floating grounds are formed so that the second passive two terminal circuit is connected between all or a part of the adjacent divided floating grounds.
